(19) United States
(12) Patent Application Publication
(10) Pub. No.: US 2015/0070188 A1
(43) Pub. Date: Mar. 12, 2015

(54) MONITORING DEVICE AND METHOD OF USE

(71) Applicant: Soil IQ, Inc., Oakland, CA (US)

(72) Inventor: Jason Aramburu, Oakland, CA (US)

(21) Appl. No.: 14/481,281

(22) Filed: Sep. 9, 2014

Related U.S. Application Data
(60) Provisional application No. 61/875,579, filed on Sep. 9, 2013.

(51) Int. Cl. G01F 15/06; A01G 27/00

(52) U.S. Cl. CPC G01F 15/063; A01G 27/003
USPC 340/870.02

(57) ABSTRACT

A garden management system including a monitoring device, the monitoring device including a soil sensor; a body including a set of ambient environment sensors, a geographic location mechanism, a wireless communication mechanism, a power supply electrically connected to and configured to power the soil sensor, ambient environment sensors, wireless communication mechanism, and geographic location mechanism; and a renewable power source electrically connected to and configured to charge the power supply with harvested renewable power; and a set of supports connecting the body to an end of the soil sensor, the body cooperatively defining a handle void with the set of supports.

### CROSS-REFERENCE TO RELATED APPLICATIONS

This application claims the benefit of U.S. Provisional Application No. 61/875,579 filed 9 Sep. 2013, and U.S. Provisional Application No. 62/006,682 filed 2 Jun. 2014, which are incorporated in its entirety by this reference.

### TECHNICAL FIELD

This invention relates generally to the monitoring field, and more specifically to a new and useful substrate monitoring device in the monitoring field.

### BRIEF DESCRIPTION OF THE FIGURES

FIGS. 1A and 1B are a cutaway view and a top view of a schematic representation of a variation of the monitoring device.

FIGS. 2A, 2B, and 2C are an isometric view from the top, an isometric view from the bottom, and an elevation view of a variation of a probe monitoring device, respectively.

FIG. 3 is an elevation view of a second variation of the probe.

FIGS. 4A and 4B are an isometric view from the top and an isometric view from the bottom of a third variation of the probe, respectively.

FIGS. 5A and 5B are a top and bottom view of a second variation of the monitoring device.

FIG. 6 is an isometric view of a smart valve variation of the monitoring device.

FIG. 7 is a schematic representation of the components within a variation of the smart valve.

FIG. 8 is a cutaway schematic representation of a variation of the probe monitoring device inserted into a substrate.

FIG. 9 is a schematic representation of a method of monitoring device operation.

FIG. 10 is a schematic representation of an example method of monitoring device operation.

FIG. 11 is a schematic representation of the monitoring devices deployed in a substrate.

FIG. 12 is a schematic representation of a variation of monitoring device power management.

FIG. 13 is a schematic representation of a variation of device baseline determination.

FIG. 14 is an example of an electrical conductivity log for a monitoring device.

FIG. 15 is an example of treatment and contamination detection based on the measured parameter values.

FIG. 16 is a schematic representation of notification and recommendation determination based on the measured parameter values and secondary data sources.

FIGS. 17 and 18 are schematic representations of examples of system outputs at a user device.

FIG. 19 is a schematic representation of historical plot data display at a user device.

FIG. 20 is a schematic representation of a second variation of monitoring device power management.

FIG. 21 is a schematic representation of a third variation of monitoring device power management.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Monitoring Device

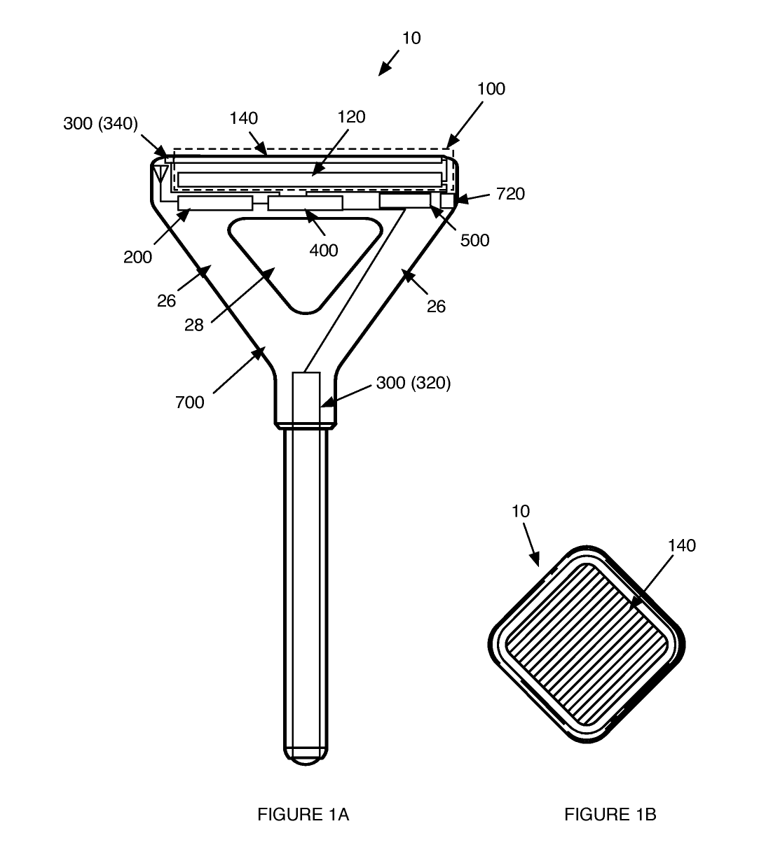

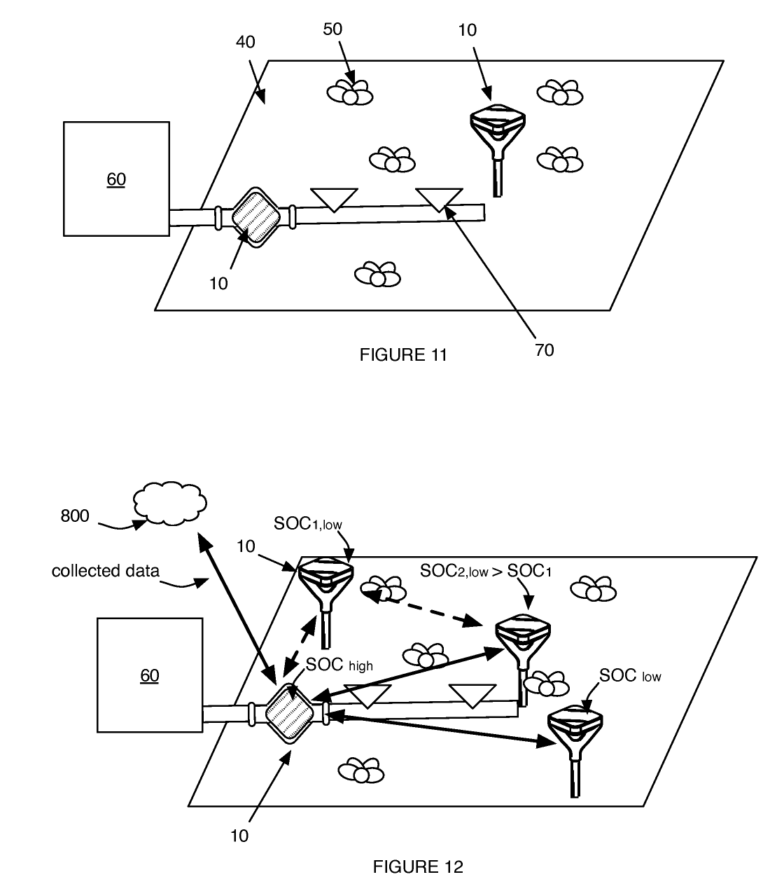

As shown in FIG. 1, the monitoring device 10 includes a power source 100, a data communication mechanism 200, a set of sensors 300, and a computing mechanism 400. The monitoring device 10 can additionally include a location mechanism 500, a control mechanism, or any other suitable component. The monitoring device 10 functions to measure ambient environment and/or substrate parameter values, and to transmit the parameter data to a remote computing system. In a specific example, the monitoring device 10 is configured to monitor a garden or crop field. The parameter values can subsequently be used to generate treatment recommendations (e.g., for a plant 50, the substrate 40, or any other suitable object of interest), detect anomalies, or for any other suitable purpose. The substrate 40 is preferably soil (e.g., of an indoor or outdoor garden), as shown in FIG. 11, but can alternatively be water (e.g., a swimming pool) or any other suitable substrate. The monitoring device 10 can additionally function to log the parameter values, process the parameter values, or perform any other suitable function. The monitoring device 10 can be a probe 20, a valve, drone, or have any other suitable form factor.

The power source 100 of the monitoring device 10 functions to supply power to the monitoring device 10. The power source 100 is preferably power storage 120, but can alternatively or additionally be a power grid or any other suitable power source. The power storage 120 is preferably a battery, but can be any other suitable power storage. The battery is preferably a secondary battery (e.g., a rechargeable battery), but can alternatively be a primary battery or any other suitable battery. The battery can be a lithium ion battery, a lithium polymer battery, a nickel cadmium battery, or have any other suitable chemistry. The power source can additionally include any suitable battery management circuitry.

The power source 100 can additionally include a power harvesting system (renewable power source) 140 electrically connected to and configured to supply power to the power storage 120. Alternatively, the power storage 120 can be charged by a static power source (e.g., a power grid), a fuel cell system, or any other suitable power supply. The power harvesting system 140 preferably harvests power from an erratic power supply, but can alternatively harvest power from a substantially constant or predictable power supply. The power harvesting system 140 can be a solar panel, wind system, wave system, or any other suitable power harvesting system that harvests power from the ambient environment. The power storage 120 preferably functions as a power sink and power source to buffer the monitoring device 10 from changes in the amount of power harvested by the power harvesting system 140. Alternatively, the system can only include a power harvesting system 140, wherein the monitoring device 10 dynamically adjusts power consumption to accommodate for increases and decreases in the power supplied by the power harvesting system 140.

The data communication mechanism 200 of the monitoring device 10 functions to transmit and/or receive data from a remote computing system (e.g., remote server system), other monitoring devices (e.g., probes, valves, drones, etc.), a user device (e.g., a smartphone, tablet, laptop, or other user device), local router, or any other suitable device. The data communication mechanism 200 preferably includes a data receiver, and can additionally include a data transmitter. The data receiver and data transmitter can be the same communication technology, or can be different communication technologies. The data communication mechanism 200 is preferably a wireless communication mechanism, but can alternatively be a wired communication mechanism or any other suitable mechanism. The monitoring device 10 can include one or more data communication mechanisms. The data communication mechanism 200 can be a long-range communication mechanism, such as WiFi or cellular, or can be a short-range communication mechanism, such as RF, NFC, or any other suitable short-range communication mechanism. The monitoring device 10 can include one or more data receivers and/or data transmitters. The data receiver and/or data transmitter can be 802.11x, Wi-Fi, Wi-Max, NFC, RFID, Bluetooth, ZigBee, cellular telecommunications protocols (e.g., 3G, 4G, LTE, etc.), radio (RF), a combination thereof, or include any other suitable communication technology.

The data communication mechanism 200 can additionally or alternatively include a mesh networking module capable of establishing a mesh network with secondary monitoring devices 10. The secondary monitoring devices 10 are preferably within a threshold geographic distance of each other, but can alternatively share a common feature, such as being associated with a common user account, user device, communications base, or any other suitable feature. The mesh networking protocol is preferably a routing technique, but can alternatively be a flooding technique or any other suitable networking technique.

The data communication mechanism 200 can include a set of antennas. The antenna can extend along the perimeter of the monitoring device body, along the length of a support retaining the relative position of the body relative to an extension portion 24, along a portion of the probe, along a longitudinal axis of the monitoring device 10, along a broad face of the monitoring device 10, or along any other suitable portion of the monitoring device 10. The antenna can be a loop antenna, dipole antenna, slot antenna, or any other suitable antenna.

The monitoring device 10 preferably includes a high-power data communication mechanism 200 (e.g., a high power consumption data transmitter or receiver) and a low-power data communication mechanism (e.g., a low power consumption data transmitter or receiver). In a specific example of the monitoring device 10, the monitoring device 10 includes a high power data transmitter and a low power data receiver. However, the monitoring device 10 can include any other suitable data communication mechanism.

In one variation of the monitoring device 10, the data transmitter and/or receiver selected for use can be selected based on the instantaneous power storage state of charge (SOC). The utilized data transmitter and/or receiver can additionally be selected based on predicted power storage SOC (e.g., based on the instantaneous ambient environment parameter values, weather forecasts received from remote servers, etc.). For example, a high power data transmission mechanism can be selected in response to the power storage SOC exceeding a SOC threshold, and a low power data transmission mechanism can be selected in response to the power storage SOC falling below a second SOC threshold. The type of data communication mechanism 200 selected can additionally or alternatively be based on the operation states (e.g., power states) of secondary monitoring devices connected to the monitoring device 10 (e.g., physically, wirelessly, electronically, etc.). For example, as shown in FIG. 12, a low power data transmitter can be selected for use in response to the instantaneous or predicted power storage SOC of a second monitoring device 10 exceeding a predetermined threshold, wherein the second monitoring device 10 preferably transmits the data for the first and second monitoring device 10 to the remote server through a high power data communication mechanism. The second monitoring device 10 can additionally function as a hub to receive data from the remote computing system, and communicate the received data to the other networked monitoring device 10 through the low power data transmitter.

The memory of the monitoring device 10 functions to store parameter measurements. The memory can store the parameter measurements for a predetermined period of time, until the stored data has been transmitted to a second device, or for any other suitable duration. The memory can additionally function to store data received from the secondary device (e.g., remote server, user device, etc.), such as weather forecasts, social networking system information, or any other suitable information. The memory is preferably flash memory, but can alternatively be any other suitable data storage mechanism.

The sensors 300 of the monitoring device 10 functions to measure parameters of the ambient environment. The monitoring device 10 can include soil sensors 320 that measure soil parameters (e.g., below-ground parameters), ambient environment sensors 340 that measure ambient environment parameters (e.g., above-ground parameters), or any other suitable sensors. The parameters measured by the monitoring device 10 can include substrate ion concentrations (e.g., nitrogen, phosphorous, potassium, micronutrients, etc.), substrate pH, substrate temperature, moisture, conductivity, resistivity, ambient environment (e.g., air) humidity, temperature, light intensity, light spectra, optical information (e.g., images of the ambient environment and/or a subject of interest, such as a crop), audio information, or any other suitable parameter of the environment and/or substrate proximal the monitoring device 10. Sensors that can be used include a light sensor, a humidity sensor, a temperature sensor, an electrical conductivity meter (e.g., a potentiometric EC meter, an inductive EC meter, etc.), an ion meter (e.g., calcimeter, etc.), an optical sensor (e.g., CCD, etc.), an acoustic sensor (e.g., microphone), a soil moisture sensor (e.g., a frequency domain sensor, neutron moisture gauge, electrical conductivity meter, time domain transmission, heat dissipation sensor, etc.), or any other suitable sensor. In a specific variation of the electrical conductivity meter, the electrical conductivity meter includes a first and second electrode serially and concentrically arranged along the longitudinal axis of the probe. The electrical conductivity meter can additionally include an electrical insulator that electrically isolates the first electrode from the second electrode. The electrical conductivity meter can additionally include a second electrical insulator that electrically insulates the first electrode from the remainder of the probe body. However, the electrical conductivity meter can be otherwise configured.

The computing mechanism 400 of the monitoring device 10 functions to process the signals from the sensors 300, and can additionally control the frequency of data transmission (data transmission rate), the frequency and/or duration of data communication mechanism operation, the frequency of data receipt, the operation mode of any control mechanism, or any other suitable monitoring device functionality. The computing mechanism 400 can additionally function to adjust a measurement from a first sensor based on the measurement from a second sensor. For example, the computing mechanism 400 can adjust soil sensor measurements (e.g., conductivity measurements) base on the ambient environment measurements (e.g., temperature). The computing mechanism 400 is preferably a printed circuit board, but can alternatively be any other suitable processor.

The computing mechanism 400 is preferably configured to determine and record a timestamp, wherein the timestamp is preferably a universal timestamp, but can alternatively be any other suitable timestamp. The computing mechanism 400 is preferably time-synchronized with the computing mechanisms of other monitoring devices, and can additionally be time-synchronized with the user device, the remote computing system, or any other suitable device. The computing mechanism 400 can be synchronized through a commonly shared remote computing system (e.g., remote server), but can alternatively be synchronized through direct communication with a device (e.g., a user device) within a given geographic location (e.g., predetermined distance, geofence, etc.), with the other components associated with a user account (e.g., other monitoring devices), or with any other suitable devices.

The computing mechanism 400 can additionally function to control secondary components (e.g., valve) and/or functionalities (e.g., water application, fertilizer application, shade application, light application, etc.) based on measured parameter values and/or commands received from devices, such as a user device, a remote computing system, or any other suitable device. The computing mechanism 400 can additionally monitor and/or predict the state of charge (SOC) of the power storage (e.g., based on the instantaneous ambient parameter measurements, the predicted ambient parameter measurements, etc.).

The computing mechanism 400 can additionally function to manage device power. The computing mechanism 400 can dynamically manage device power by dynamically selecting the data communication frequency (rate) and/or mechanism, but can alternatively control power consumption in any other suitable manner.

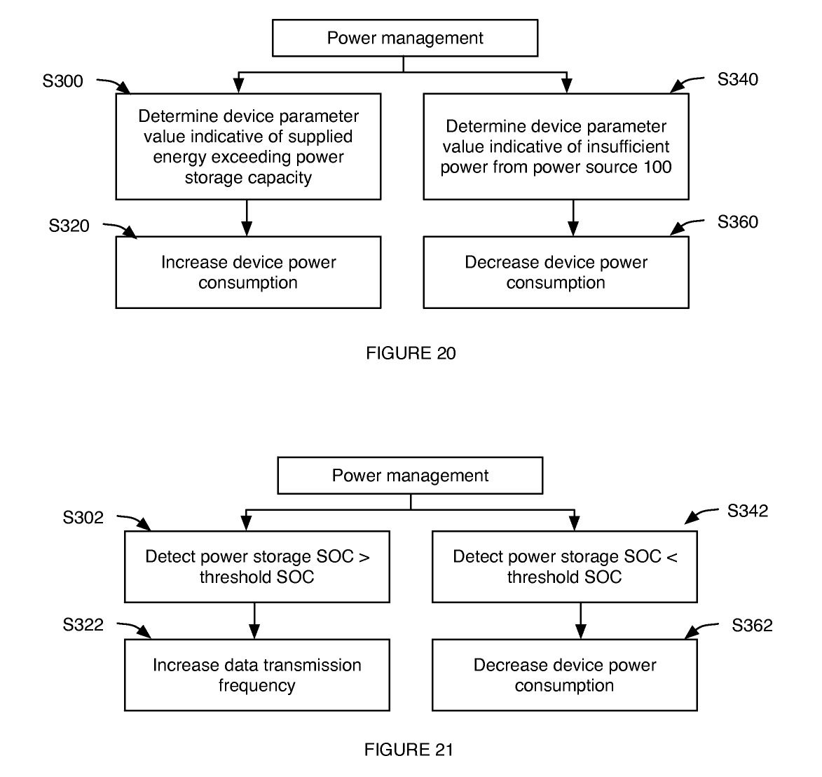

In one variation of the monitoring device 10 as shown in FIG. 20, the computing mechanism 400 performs a variation of the method of power management. In this variation, the method can include: in a first computing mechanism operation mode, increasing device power consumption S320 in response to determining device parameter value indicative of supplied energy exceeding power storage capacity S300, and in a second computing mechanism operation mode, decreasing device power consumption S360 in response to determining device parameter value indicative of supplied energy falling below the power storage capacity S340.

In one example of the variation, the computing mechanism 400 is operable between a first mode, wherein the monitoring device energy consumption rate is increased S320 in response to the power supply rate exceeding a threshold rate, and decreased S360 in response to the power supply rate falling below a threshold rate. In one example as shown in FIG. 21, the computing mechanism 400 operates in the first mode in response to a renewable power parameter exceeding a parameter threshold; and operates in the second mode in response to the renewable power parameter falling below a second parameter threshold. In a specific example, in the first mode, the processor increases power consumption by controlling the wireless communication mechanism to transmit information more frequently S322; in the second mode, the processor decreases power consumption by controlling the wireless communication mechanism to transmit information less frequently S362. However, the computing mechanism 400 can control the sensor data collection rate, which sensors 300 are in operation, or control any other suitable operation aspect of the monitoring device 10 to control energy consumption to substantially meet or accommodate for variations in the power supply. Alternatively, the sensors 300, communication mechanism 200, or any other suitable component can be directly powered from the renewable power source in the first mode, and powered from the power supply in the second mode. In this variation, the power supply can be trickle charged or not charged in the first mode, and charged at full or maximum available power in the second mode. However, the power-consuming components and power supply can be charged in any other suitable manner. Alternatively, the power can be managed using a combination of the above, or managed in any other suitable manner.

The renewable power parameter preferably includes the anticipated power provision rate from the renewable power supply, but can alternatively be the instantaneous power provision rate from the renewable power supply, or be any other suitable parameter. The anticipated power supply rate can be determined by the processor, a remote server, a user device, or any other suitable computing mechanism based on the instantaneous power supply rate, an ambient environment parameter (e.g., ambient light intensity for a solar power system, wind speed for a wind power system, etc.), weather forecasts based on the geographic location of the monitoring device 10, as determined from the location mechanism 500 and an on-board or remote storage system (e.g., cloudiness, wind speed, rain, etc.), duration of sunlight availability (e.g., length of the day), any combination of the above, or based on any other suitable parameter. The parameter threshold is preferably dynamically determined based on the power storage SOC, and can be the remaining power capacity in the power storage (e.g., 10% when the power storage SOC is 90%), the difference between the instantaneous SOC and a threshold SOC (e.g., wherein the threshold SOC can be 100%, 90%, or any other suitable threshold stopping SOC), the instantaneous or anticipated rate of power consumption by the monitoring device 10 relative to the power storage SOC, or determined based on the power storage SOC in any other suitable manner. Alternatively, the parameter threshold can be predetermined, determined as a function of a target power storage SOC and the instantaneous or anticipated power consumption rate, or otherwise determined. The parameter threshold can be an energy magnitude (e.g., Watts), power magnitude (e.g., W/s), SOC, or any other suitable energy measure. The adjustment parameters are preferably already determined as inputs for plant recommendation or other output determination, but can alternatively be specifically measured for energy consumption adjustment.

In a second variation, the computing mechanism 400 can control power consumption from the power storage based on the power storage SOC. This variation can indirectly accommodate for changes in power supplied from the power supply by monitoring the power storage SOC. In this variation, as shown in FIG. 21, the computing mechanism 400 is operable between a first mode, wherein the monitoring device energy consumption rate is increased in response to the power storage SOC exceeding a threshold SOC S302, and decreased in response to the power storage SOC falling below a threshold SOC S342. In one example, in response to the power storage SOC exceeding first threshold SOC, the computing mechanism 400 can increase the data transmit and/or remote server connection frequency and/or select a high-power data communication mechanism. The frequency can be predetermined, selected based on difference between instantaneous SOC and first threshold SOC, or determined in any other suitable manner. In response to the power storage SOC falling below a second threshold SOC, the computing mechanism 400 can decrease the data transmit and/or remote server connection frequency and/or select a low-power data communication mechanism. The second threshold SOC is preferably lower than the first threshold SOC, but can alternatively be the same, higher, or any other suitable SOC value. The second frequency can be predetermined, selected based on difference between instantaneous SOC and first threshold SOC, or determined in any other suitable manner. The monitoring device 10 preferably measures the ambient environment parameters at a predetermined frequency independent of the power storage SOC, but can alternatively adjust the measuring frequency (e.g., increase or decrease) as a function of the power storage SOC. However, the computing mechanism 400 can control monitoring device operation in any other suitable manner.

The monitoring device 10 can additionally include an in-line charger electrically connected between the power supply (e.g., renewable power supply) and the power storage. The in-line charger preferably functions to selectively connect and/or disconnect the power storage from the power supply based on the power supply and/or power storage parameters. The in-line charger can additionally function to condition the power supply power into power suitable for the power storage. In one example, the in-line charger can connect the power storage to the power supply in response to the power storage SOC falling below a first SOC threshold, and disconnect the power storage from the power supply in response to the power storage SOC exceeding a second SOC threshold, wherein the second SOC threshold can be equal to, higher than, or lower than the first SOC threshold. In a second example, the in-line charger can connect the power storage to the power harvesting mechanism in response to the anticipated power supply rate from the power harvesting mechanism falling below a first threshold rate, and disconnect the power storage from the power harvesting mechanism in response to the anticipated power supply rate from the power harvesting mechanism exceeding a second threshold rate. The first threshold rate can be can be equal to, higher, or lower than the second threshold rate. However, the in-line charger can selectively control power storage charging by the power harvesting mechanism in any other suitable manner.

In one variation of the monitoring device 10, in response to determination of user device connection with a remote computing system and/or user account activity, the computing mechanism 400 preferably switches the data communication frequency from a first frequency to a second frequency (e.g., a high frequency, higher than the first frequency, etc.). In response to determination of user device disconnection and/or lack of user account activity, transmitting at the first frequency or a third frequency lower than the second frequency. However, the computing mechanism 400 can control the device communication frequency in any other suitable manner.

The monitoring device 10 can additionally include a location mechanism 500 that functions to transmit the monitoring device geographic location to a secondary device (e.g., user device, remote server, etc.). The monitoring device location can subsequently be used to determine forecasts (e.g., weather forecasts), historical information (e.g., based on monitoring devices and/or user accounts associated with geographic locations within a predetermined region of the instantaneous monitoring device location), substrate information (e.g., the hardiness zone associated with the device location), neighboring devices, or any other suitable location-based data for the monitoring device 10. The location data can be GPS coordinates provided by a processing device, triangulation between mobile phone towers and public masts (e.g., assistive GPS), Wi-Fi connection location or identifier, WHOIS performed on IP address or MAC address, GSM/CDMA cell identifiers, self-reported location information, or any other suitable location information. In some embodiments, location information includes position (e.g., latitude and longitude), elevation, heading, speed, orientation, and combinations thereof. The location mechanism 500 can be a GPS unit, a cellular tower triangulation unit, or any other suitable location mechanism. The location mechanism 500 can include a set of antennas, processors, compasses, or any other suitable sub-component.

The monitoring device 10 can additionally include a control mechanism 600 that functions to control a physical parameter of the ambient environment. The control mechanism 600 is preferably operable between a first and a second mode, but can alternatively be operable between any other suitable set of modes. The computing mechanism 400 preferably controls the control mechanism operation mode, but the control mechanism 600 can be controlled by any other suitable device (e.g., the user device, remote server, etc.). The computing mechanism 400 can additionally function to determine whether there is or will be sufficient power stored in the power storage to actuate the control mechanism into a second mode (e.g., an off mode) before actuating the control mechanism into a first mode (e.g., an open mode). The control mechanism 600 is preferably an active valve 620 (as shown in FIG. 7), but can alternatively be a light or any other suitable control mechanism capable of adjusting an environmental parameter. The active valve 620 is preferably operable between an open mode and a closed mode, but can alternatively be operable in any suitable position between the open and closed positions to control the flow rate therethrough. The valve 620 is preferably a positive pressure valve, but can alternatively be any other suitable valve. The active valve 620 is preferably controlled by a solenoid, more preferably a magnetic latch solenoid, but can alternatively be controlled by any other suitable solenoid or any other suitable control mechanism.

The monitoring device 10 can additionally include a switch 720 that functions to switch the monitoring device 10 between a first and a second operation mode. The first mode can be a low power-consumption mode (e.g., off) and the second mode can be a high power-consumption mode (e.g., on). The switch can control the monitoring device 10, can cease data measurement and/or communication in the low power consumption mode, and measure and/or send data in the high power consumption mode. The switch is preferably a magnetic switch responsive to externally applied magnetic field, wherein each subsequent application of the magnetic field serially cycles the monitoring device through the set of operation modes. However, the switch can be an exposed switch (e.g., a push button), or any other suitable switch.

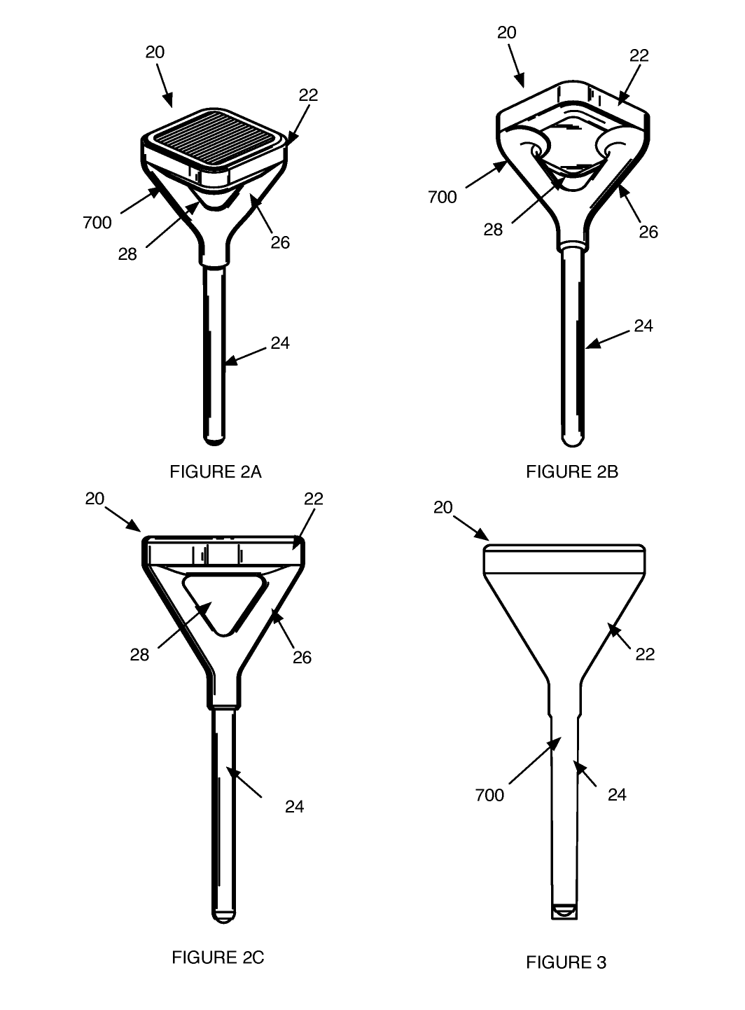

All or a part of the monitoring device 10 is preferably encased within a casing (housing) 700 that functions to mechanically support and protect the monitoring device components. The monitoring device 10 is preferably hermetically sealed, but can alternatively be sealed in a water-impermeable casing, sealed in a gas-impermeable casing, sealed in a liquid- or gas-permeable casing, or be enclosed in any other suitable casing. The monitoring device 10 is preferably substantially entirely hermetically sealed, as shown in FIG. 3. In this variation, the casing preferably includes sensor apertures (e.g., for the light sensor or humidity sensor), wherein a portion of the sensor, potting material, or other component cooperatively forms a hermetic seal with the casing body surrounding the aperture to hermetically seal the monitoring device. However, the casing can include no apertures or be otherwise sealed. Alternatively, as shown in FIGS. 2A and 2B, the monitoring device 10 can be divided into a body portion 22 that retains a subset of the monitoring device components (e.g., the power supply and processor), and an extension portion 24 that retains a second subset of the components (e.g., the sensors 300 and power harvesting mechanism 140). The casing 700 can selectively hermetically seal all or part of the body portion 22 and/or the extension portion 24. When a subset of the components is sealed, the exposed components are preferably connected to the sealed components by electrodes, wherein the electrodes are substantially sealed when coupled to the corresponding electrodes. However, the monitoring device 10 can be divided in any other suitable set of collections and any other suitable portion of the monitoring device 10 can be sealed in any other suitable manner. The casing 700 is preferably a plastic casing, but can alternatively be a rubber coating or any other suitable material. When the monitoring device 10 is hermetically sealed, the monitoring device 10 preferably includes the magnetic switch, but can alternatively include any other suitable switch. The casing 700 can additionally function to define any fluid channels, coupling channels, or any other suitable feature of the monitoring device 10.

The monitoring device 10 can additionally include a body portion 22 that supports all or a subset of the monitoring device components. The body portion 22 is preferably encapsulated by the casing 700, but can alternatively be defined by any other suitable component. The body portion 22 of the casing 700 preferably includes a broad face, but can alternatively include any other suitable surface. The body portion 22 of the casing 700 is preferably substantially rectangular prismatic, but can alternatively be spherical, ovular, polygonal prismatic, or have any other suitable configuration.

The monitoring device 10 can additionally include an extension portion 24 extending from a body portion 22, wherein the extension portion 24 functions to support and maintain the monitoring device position within the substrate. The extension 24 can additionally function to support one or more sensors 300, such as the electrical conductivity meter and/or ion meters. Alternatively, the extension 24 can be formed by one or more sensors 300 (e.g., the soil sensors 320). The extension 24 can be encapsulated by the casing 700, encapsulated by a secondary casing 700 separate from that enclosing the body portion 22, or entirely or partially exposed. The extension 24 preferably includes a longitudinal body terminating in a conical tip with a sharp or rounded end, but can alternatively terminate in a substantially flat tip or have any other suitable configuration. The extension 24 preferably extends from the casing 700 distal the power harvesting mechanism, but can alternatively extend from any other suitable portion of the casing 700. In one example, the longitudinal axis of the extension 24 extends normal to the power harvesting mechanism and/or casing broad face. The extension 24 can extend directly from a face of the casing, or can be offset from the main body 22 by a set of supports 26, as discussed below. The extension 24 can additionally include a flange arranged a predetermined distance from the tip of the body extension 24 distal the power harvesting mechanism that functions to control the distance of body extension insertion into a substrate (e.g., soil). The extension 24 can additionally and/or alternatively include a temperature sensor, ion sensor, or any other suitable sensor. The extension 24 is preferably thermally conductive, and can function to thermally conduct heat from the components in the body to the substrate, wherein the substrate can function as a heat sink. Alternatively, the extension 24 can be thermally insulated, or configured in any other suitable manner.

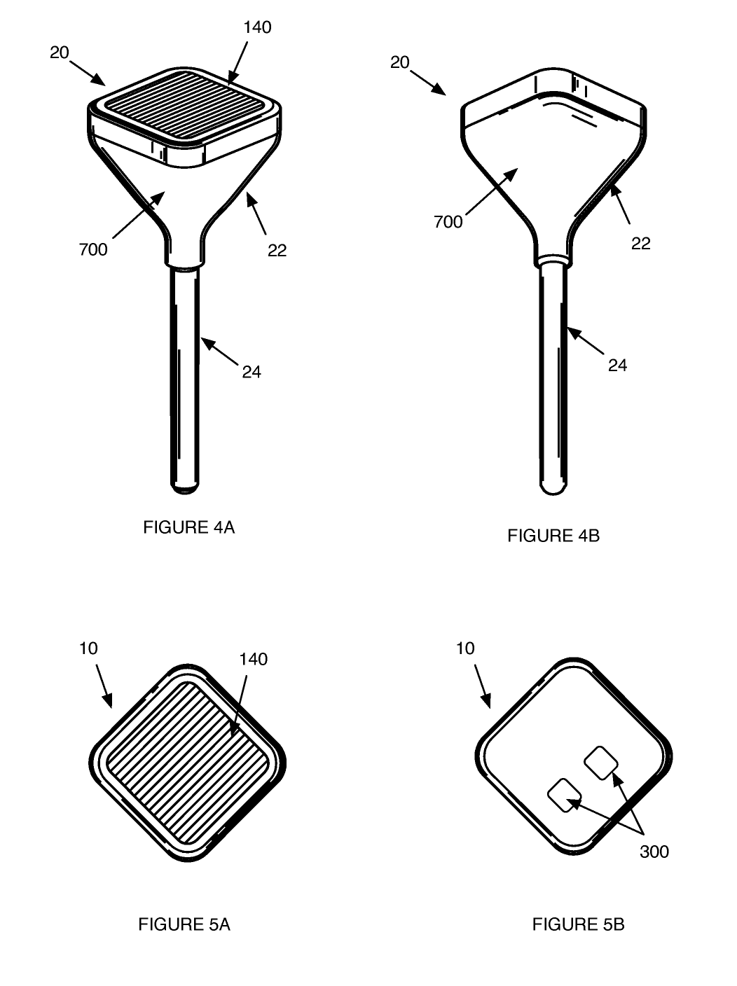

As shown in FIGS. 2A and 2B, the monitoring device 10 can additionally include a set of supports 26 that function to retain the extension 24 relative to the body 22. The body portion 22 of the casing 700 preferably extends over all or a portion of each support, but the supports 26 can alternatively be exposed from the casing 700. The set of supports 26 can additionally function to cooperatively form a handle void 28 with the body 22, wherein the body 22 functions as a handle for body extension insertion and/or retraction from the substrate, as shown in FIG. 8, and the supports 26 function as a set of force transfer mechanisms between the body 22 and the body extension 24. The handle void 28 preferably functions to permit user hand, finger, or other force application mechanism insertion therethrough. The supports 26 are preferably rods, but can alternatively be beams, trusses, or any other suitable support. The set of supports 26 are preferably formed from steel, but can alternatively be plastic or any other suitable material. Alternatively, the set of supports 26 can form a substantially continuous connection between the body 22 and extension 24 that lacks any voids, as shown in FIGS. 4A and 4B. The set of supports 26 can additionally or alternatively include gripping features, such as divots, protrusions, texture, or any other suitable feature. The set of supports 26 are preferably connected at a first end to an end of the body extension 24 opposing the tip, and connected at a second end to an edge of the body 22 proximal the extension 24. However, the set of supports 26 can alternatively be connected to a longitudinal side of the extension 24, to a portion of the broad face of the body 22, to the entirety of the body broad face, to a side of the body 22, or to any other suitable portion of the body 22 or extension 24. In a specific variation, the monitoring device 10 includes a first and second support, each connected to the body extension 24 at a first end and connected to an opposing corner of the body 22 at a second end. However, the body 22 can be otherwise configured.

### 2. Monitoring Device Exam

As shown in FIGS. 2A and 2B, in a first variation, the monitoring device 10 is a probe 20. The probe 20 preferably includes a body 22 that includes the data communication mechanism, power storage, memory, computing mechanism 400, switch, and one or more sensors 340, such as the temperature sensor, humidity sensor, and light sensor. However, the body 22 can include any other suitable component. The body 22 preferably additionally supports the power harvesting mechanism. In one example, the power harvesting mechanism is supported along a first broad face of the body 22. The power harvesting mechanism can be recessed into the body 22 or be flush with the casing 700, wherein the casing 700 can further include a bezel (e.g., a rounded bezel) terminating at the broad face of the power harvesting mechanism, such that liquid beaded onto the power harvesting system flows down the bezel off the power harvesting mechanism. The probe additionally includes a longitudinal extension 24 that functions to support the soil sensors 320, and can additionally support the temperature sensors or any other suitable sensors. In a specific example, the body is substantially rectangular prismatic, and can have a width of approximately 7 cm, a height of approximately 7 cm, and a thickness of approximately 2.5 cm. However, the body can have any other suitable dimension. The body preferably has rounded corners, but can alternatively have sharp corners, profiled corners, or any other suitable profile. The extension 24 preferably includes a longitudinal axis and defines a conical tip. In a specific example, the extension 24 is substantially sealed (e.g., water-impermeable), and the tip is exposed. However, any other suitable portion of the extension 24 can be sealed. The extension 24 is preferably retained a distance away from the body 22 by a first and second support, wherein the first and second supports 26 each have a first end coupled to an end of the extension 24 distal the extension tip and a second end coupled to an opposing corner of the body 22. The body 22 and first and second supports 26 cooperatively define a handle void 28 therebetween. The handle void is preferably triangular (e.g., equilateral) with 4 cm sides, but can alternatively be ovular, circular, or have any other suitable shape or dimension. The extension 24 is preferably arranged with the longitudinal axis perpendicular to a body broad face (e.g., the first broad face or a second broad face opposing the first broad face).

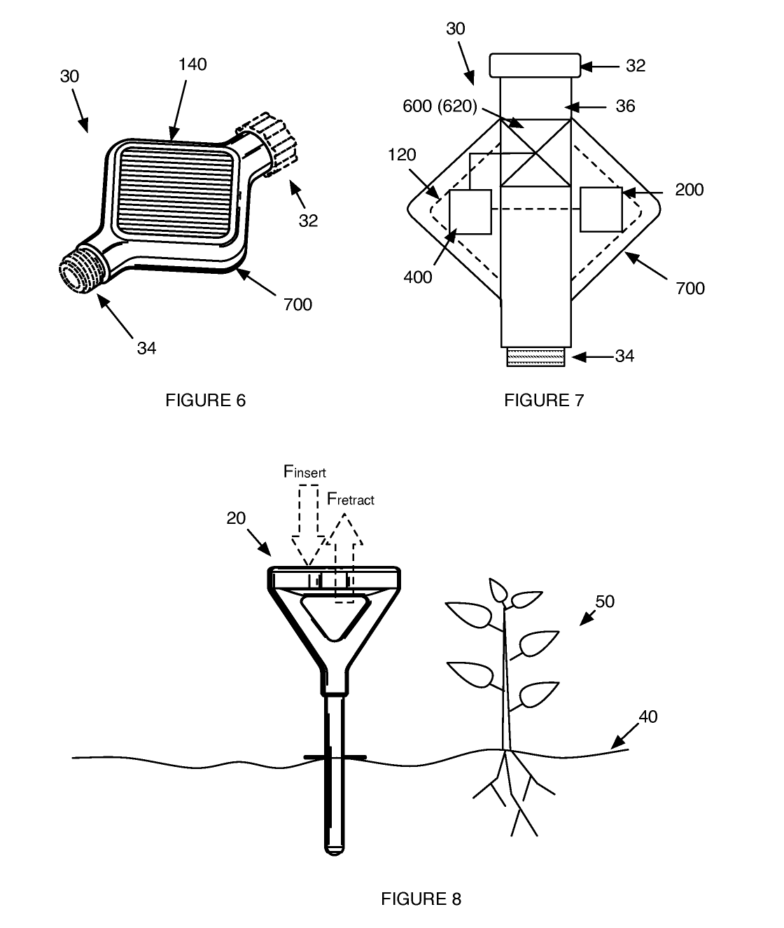

As shown in FIG. 6, in a second variation, the monitoring device 10 is a smart valve 30. The smart valve 30 can include a body 22 that includes the data communication mechanism 200, power source 100, memory, computing mechanism 400, switch, and one or more sensors 300, such as the temperature sensor, humidity sensor, and light sensor. However, the smart valve body 22 can include any other suitable component. The smart valve body 22 is preferably encased within a casing 700 that is hermetically sealed against the environment. The smart valve body 22 preferably further defines a fluid inlet 32, fluid inlet 34, and a fluid manifold 36 fluidly connecting the fluid inlet 32 with the fluid inlet 34, and additionally includes an actively controlled valve disposed across the fluid manifold 36, wherein the computing mechanism 400 can control the active valve between an open and closed position. The smart valve 30 can additionally include a flow meter fluidly connected to and configured to measure the flow rate through the fluid manifold 36. The smart valve is preferably configured to couple to a treatment supply 60 (e.g., a water supply, fertilizer supply, etc.), and can additionally or alternatively be configured to couple to a treatment dispensation mechanism 70, such as a sprinkler system, drip irrigation system, or any other suitable dispensation mechanism.

### 3. Method of Baseline Determination

The method of monitoring device baseline determination functions to establish a baseline value for the parameter measurements. A baseline for the monitoring device monitoring the substrate is preferably established in response to the occurrence of a baseline determination event. The baseline determination event can be determination of probe insertion into a substrate (e.g., as determined from a moisture, temperature, light, or other parameter change), receipt of a baseline determination command from a user account or user device associated with the monitoring device 10, a predetermined time period being met (e.g., wherein a baseline is determined for the monitoring device 10 at a predetermined frequency), or in response to the occurrence of any other suitable baseline determination event.

The baseline determination method preferably includes measuring a parameter at a first time point S100, measuring the parameter at a second time point S120, and determining a baseline for the monitoring device 10 based on the first and second measurements S130. The baselines for each monitoring device 10 can be determined independently, in conjunction with a second monitoring device 10, or using any other suitable system. A baseline can be determined for each monitoring device 10, a single monitoring device 10, wherein the baseline is shared with secondary monitoring devices, or determined for any set or subset of monitoring devices 10. However, baselines for the monitoring devices can be otherwise established.

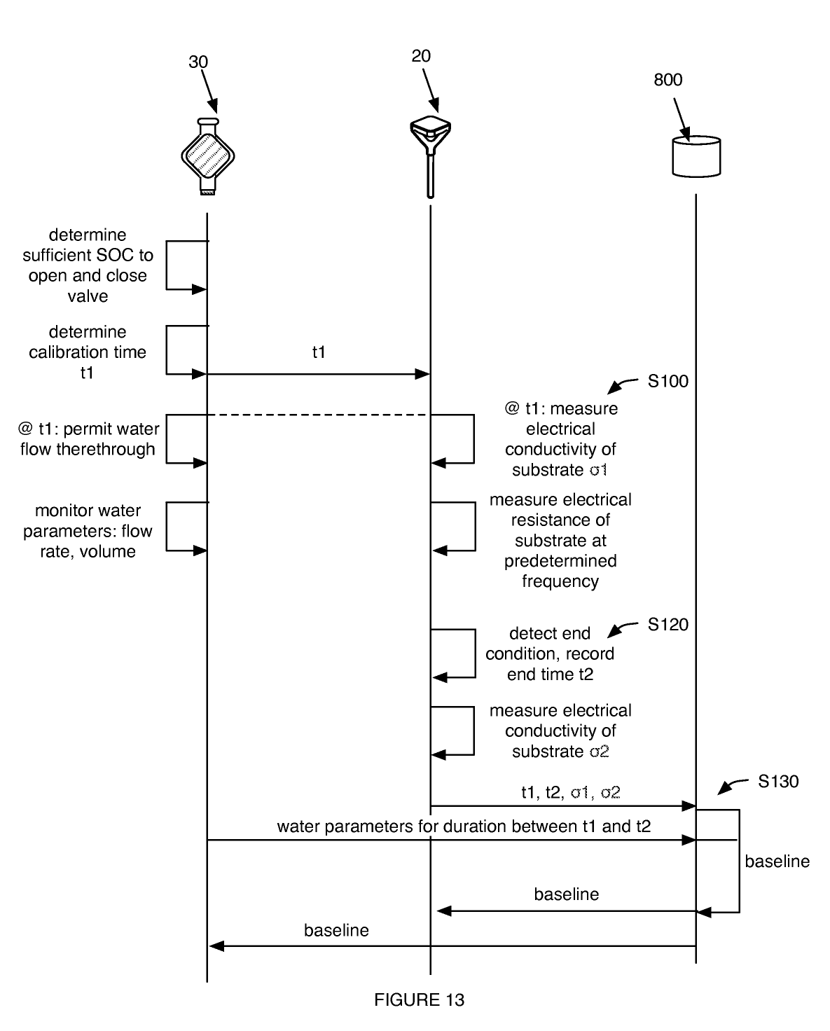

In one variation of the baseline determination method as shown in FIG. 13, the method includes determining the baseline for a probe in conjunction with a valve. Baselines for multiple probes can be simultaneously determined using a valve. However, baselines for any suitable number of probes can be determined using any suitable number of valves. The probe is preferably wirelessly connected to the valve, but can be otherwise associated with the valve. Clocks associated with (e.g., arranged on) the probe and valve are preferably synchronized, but can alternatively be asynchronous, wherein a third processor corrects for the temporal asynchronicity. The valve is preferably arranged within a threshold distance of the probe, but can alternatively control a fluid inlet 34 within a threshold distance of the probe or be otherwise arranged relative to the probe. The threshold distance is preferably determined based on the parameters of the substrate (e.g., porosity, water flow rate through the soil, physical gradients, etc.), as determined based on the geographic location of the probe and/or valve, but can be predetermined or otherwise determined.

The baseline determination method can include recording a first timestamp in response to detecting or inducing fluid flow through the fluid manifold 36 of the valve 30, recording a first parameter value for the substrate at a time within a predetermined time duration of the first timestamp with the probe S100, and recording a second timestamp in response to an end event. The first parameter value is preferably an electrical conductivity value, but can alternatively or additionally be a saturation value, resistivity value, or any other suitable parameter value. The end event can be the determination that the soil saturation has reached a saturation threshold (e.g., 100% saturation), but can alternatively be any other suitable end event, such as a target volume of liquid being dispensed through the smart valve, a target duration of liquid dispensation, or any other suitable end event. The soil saturation can be determined from a parameter of the measured soil (e.g., the electrical conductivity of the soil), wherein the saturation threshold is reached when the measured electrical resistivity falls below a resistivity threshold. In this variation, the baseline determination method can further include measuring the soil saturation, resistivity, conductivity, or any other suitable parameter with the probe at a sampling frequency within a threshold time period after the first timestamp, or include periodically determining the soil saturation in any other suitable manner. The parameter used to determine the end event can be the same parameter as the first parameter, or can be a different parameter. The sampling frequency can be predetermined, determined based on the rate of soil parameter change, or determined in any other suitable manner. The parameter threshold (e.g., the saturation threshold, resistivity threshold, conductivity threshold, etc.) can be predetermined or determined based on the type of soil (e.g., received from a user, determined based on the geographic location of the monitoring devices, etc.), determined based on the types of plants adjacent the monitoring device 10 (e.g., within a geofence or within a geographic radius of the monitoring device 10), be a predetermined value (e.g., 0.05 cm), or be determined in any other suitable manner.

The baseline determination method can additionally include recording a second parameter value for the substrate in response to occurrence of the end event S120, wherein the first and second parameter values can subsequently be used as the baseline soil conductivity range S130. The second parameter value is preferably the same parameter type as the first parameter value, but can alternatively be different. The parameter values are preferably electrical conductivity values, but can alternatively or additionally be saturation values, resistivity values, or any other suitable parameter value.

The timestamps and measurements can be used to determine soil parameters, which can subsequently be used to characterize and/or identify the soil. Examples of soil parameters include the moisture content, saturation point, and absorption rate, but any other suitable soil parameter can be determined based on the information. In a specific example, the time difference between the first timestamp and a timestamp at which a soil parameter change (e.g., a change in soil saturation or resistivity) is detected can be used to determine the absorption rate. In a second example, the rate or acceleration of change of the measured parameter value (e.g., the rate or acceleration of measured resistivity change) can be used to determine the absorption rate. In a third example, the saturation rate can be determined based on the volume of water flowed through the valve (e.g., applied to the substrate) between the first timestamp and the time at which the measured conductivity and/or resistivity stabilizes. However, parameters characterizing the soil can be determined in any other suitable manner.

The method can additionally include generating recommendations, predictions, and notifications based on deviations from the baseline range. For example, a deviation in the electrical conductivity of the soil from the baseline range can be indicative of an increase in the nitrogen, phosphorous, potassium, or micronutrient concentration in the soil, wherein the amount, rate, acceleration, or any other suitable parameter of electrical conductivity deviation can be indicative of (e.g., and subsequently used to identify) a fertilizer type, application method, contamination presence, contamination type, or any other suitable soil and/or plant treatment method. In another example, a deviation in the electrical conductivity of the soil from the baseline range differing from an electrical conductivity deviation of a neighboring plot of soil having similar treatment methods can be indicative of contamination. However, the first and second conductivity values and the time period between the first and second timestamps can be otherwise used.

A second example of the baseline determination method preferably includes recording a first electrical conductivity value and a first timestamp in response to receipt of a baseline determination command from a user device S100, measuring the soil saturation with the probe at a predetermined frequency, and recording a second electrical conductivity value and a second timestamp in response to an end event S120, such as the soil saturation surpassing the saturation threshold. A baseline range or value is preferably generated based on the first and second electrical conductivity values S130. However, baselines for the monitoring device 10 can be otherwise determined.

The method can additionally include calibrating the monitoring device 10, which functions to accommodate for monitoring device measurement drift due to sensor degradation. In one example, the EC meter can be calibrated by applying a known amount of treatment material to the soil surrounding the EC meter and determining the EC meter measurements. The resultant EC meter measurements can be subsequently remapped to result values associated with the known amounts of treatment material. For example, calibrating the EC meter can include applying known quantities of water to the soil (e.g., through the smart valve) and assigning the resultant EC meter measurement to a saturation value, wherein the saturation value can be determined based on the known quantity of applied water, historical saturation values associated with the known quantity of applied water (e.g., from the baseline determination), or determined in any other suitable manner. In another example, the EC meter can be calibrated by saturating the soil with water (e.g., using the valve), recording the EC meter measurement in association with a first saturation value, determining the amount and/or rate of water removal from the soil, taking EC meter measurements over the period of water removal from the soil, and associating the EC meter measurements with actual or estimated saturation values based on the amount and/or rate of water removed at the time of the measurement. Examples of determining water removal from the soil include determining the amount of water lost to evaporation, as determined from ambient environment sensor measurements (e.g., temperature, humidity, and light sensors), plant consumption (e.g., based on the parameter of known plants planted in the soil), runoff (e.g., based on the monitoring device location and geographical features), or from any other suitable water removal mechanism. However, the EC meter or any other sensor can be calibrated when the monitoring device is in situ using any other suitable method.

Calibrating the monitoring device can additionally include determining that the monitoring device sensor, such as an EC meter, needs to be calibrated. Determining that the monitoring device sensor needs to be calibrated can include applying a known stimulus to the sensor, determining the measured sensor value based on the known stimulus parameters (e.g., amount, rate, etc.), and calibrating the sensor in response to the measured value differing from the anticipated measured value beyond a difference threshold. For example, determining that the EC meter needs to be calibrated can include applying a volume of water to the soil in which the EC meter is located (e.g., with the valve), determining the anticipated EC meter measurement, comparing the actual EC meter measurement with the anticipated EC meter measurement, and calibrating the EC meter in response to the difference between the actual and anticipated EC meter measurement exceeding a threshold difference. Determining the anticipated EC meter measurements can be based on measurements of other EC meters monitoring the same or similar soil, historical measurements of the EC meter under the same or similar measurement conditions, historical testing results (e.g., based on a chart or graph), or otherwise determined. However, the need to calibrate the sensors can be otherwise determined.

### 4. Method of Monitoring Device Data Analysis

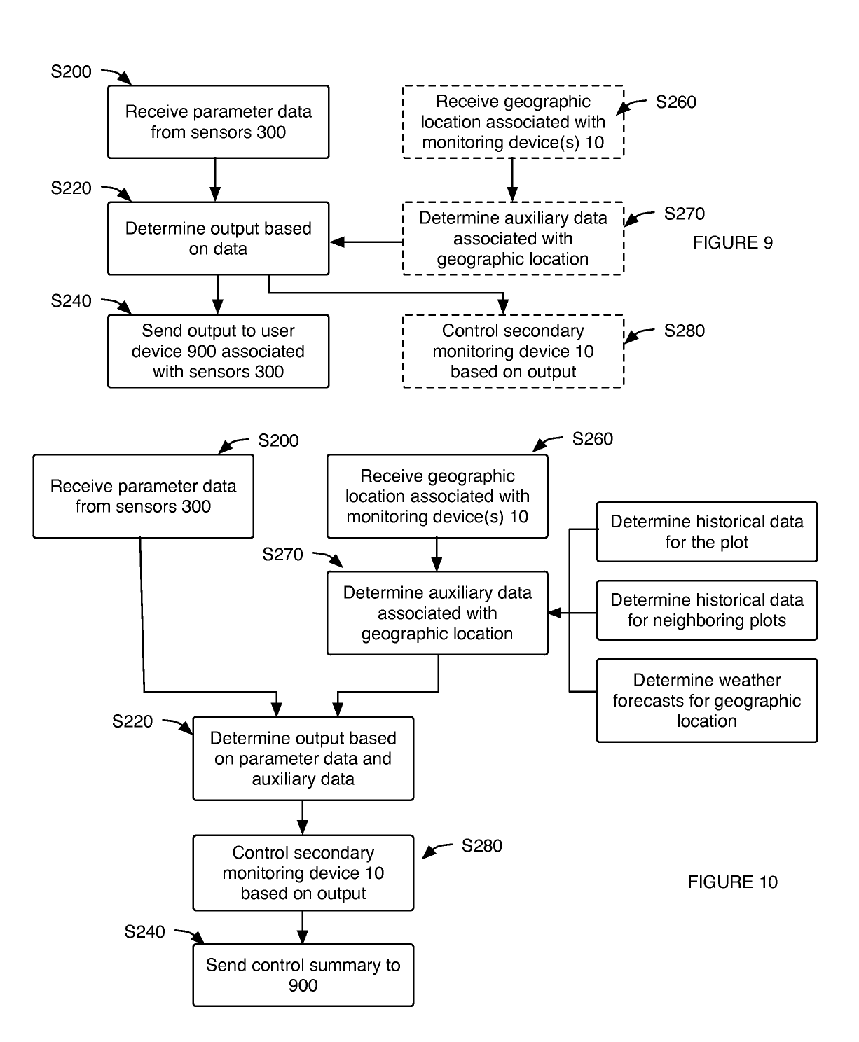

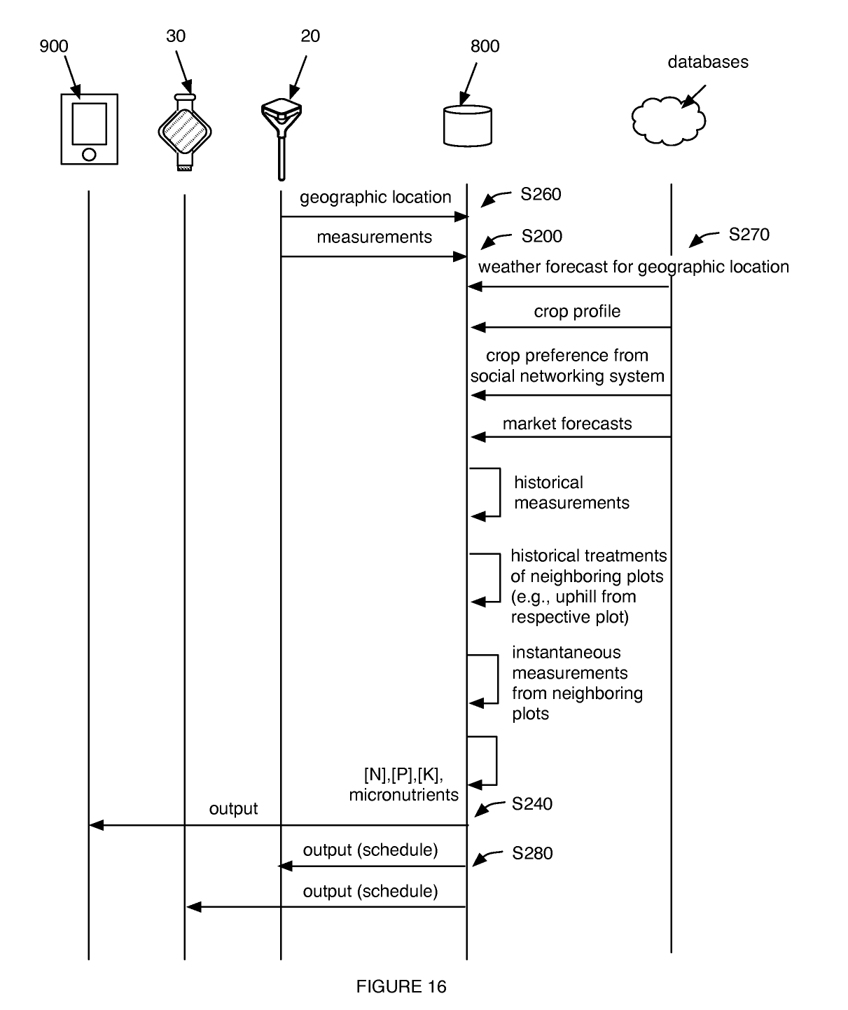

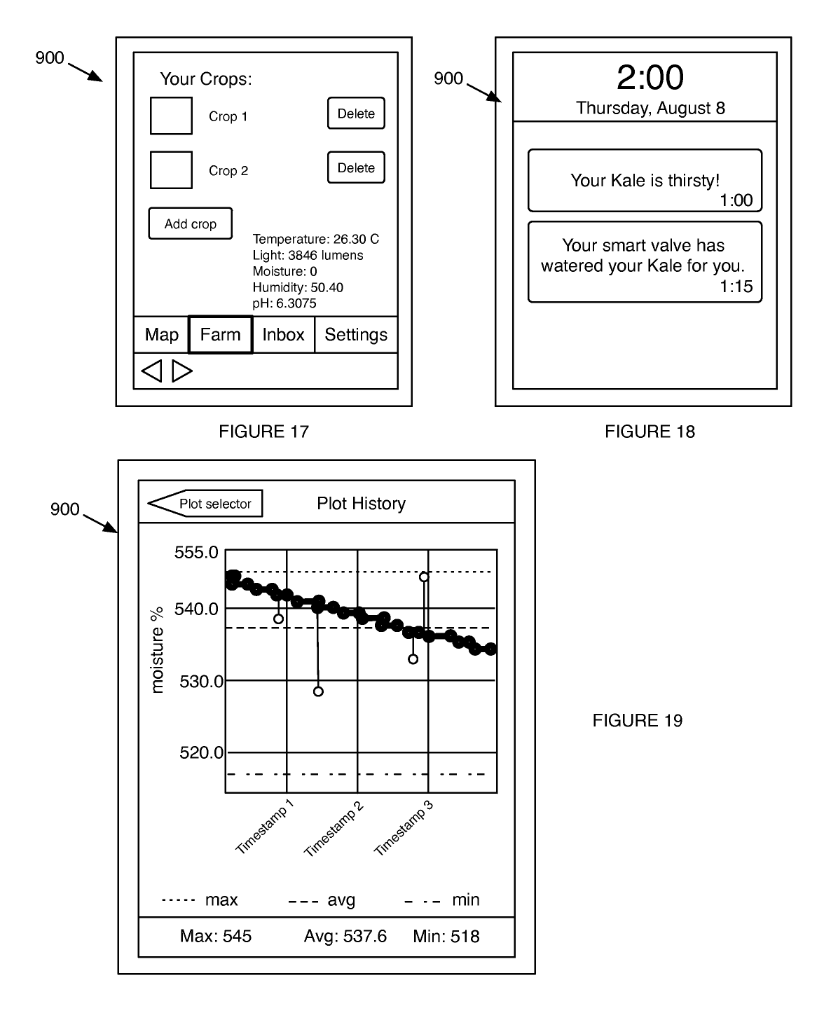

As shown in FIG. 9, the method of monitoring device data analysis includes receiving parameter data from a set of monitoring devices 10 S200, determining an output based on the parameter data S220, and sending the output to a user device 900 associated with the remote probe S300. The method can additionally include receiving a geographic location associated with the sensors 300 from the monitoring device 10, user device 900, or other computing system S260, wherein determining the output further includes determining the output based on auxiliary information associated with the geographic location, wherein the method can additionally include retrieving or otherwise determining the auxiliary information based on the geographic location associated with the soil sensor S270, as shown in FIG. 10. As shown in FIG. 16, the method of data analysis functions to generate recommendations, predictions, notifications, summaries, and/or any other suitable output based on the parameter data recorded by the monitoring devices, examples of which are shown in FIGS. 17, 18, and 19. The method can be performed by a monitoring device 10 (e.g., by the computing mechanism 400), a remote computing system 800, a user device 900, or by any other suitable processor.

The parameter data can be a soil parameter measurement, an ambient environment measurement, monitoring device operation state, or be any other suitable piece of information. The parameter data is preferably encrypted (e.g., with symmetric key encryption, public key encryption, using AES, such as 128-bit keys, etc.) by the monitoring device prior to parameter data transmission, but can alternatively be unencrypted or otherwise protected. In one variation of the method, the parameter data is preferably received from the set of monitoring devices at a remote computing system. The remote computing system preferably stores the historical parameter values for a monitoring device 10 (e.g., data beyond a time threshold, data within a time threshold, etc.), but can alternatively store the historical parameter values in association with a user account or store the parameter values in any other suitable manner. The remote computing system can additionally store the baseline value(s) for the monitoring device sensors 300, the historically applied treatments (e.g., user-entered, automatically determined based on the parameter values, or determined in any other suitable manner), or any other suitable value. However, the parameter data can be received by a second monitoring device or by any other suitable computing system. The parameter data is preferably received from the monitoring devices at the frequency the data is sent, but can alternatively be received at a lower frequency or at any other suitable frequency. The parameter data preferably includes a set of parameter values, and can additionally include the timestamps at which the parameter values were recorded. In another variation of the method, the parameter data is processed by the monitoring device 10, wherein the monitoring device 10 can receive auxiliary information from a remote device (e.g., in response to retrieval, receive an automatically-sent message, etc.). However, the parameter data can be otherwise received, stored, or processed.

Processing the parameter data functions to generate the output S220 based on the parameter data. The parameter data is preferably processed by comparing the data for a given user or plurality of users with a set of reference points, but can alternatively include comparing the data associated with a user or monitoring device 10 with historical measurements associated with the user or monitoring device 10, calculating a result based on the parameter data, or processing the data in any other suitable manner. The reference points are preferably generated by machine learning modules that were trained on the set of historical parameter data for a plurality of monitoring devices. The machine learning modules can additionally be trained on any other suitable set of inputs. Machine learning techniques can include supervised learning, statistical classification, unsupervised learning, association rule learning, clustering, or any other suitable learning method. Examples of machine learning techniques include artificial neural network, Baysean satatistics, decision trees, group method data handling, learning automata, symbolic machine learning, data clustering, or any other suitable techniques.

The parameter data is preferably determined from raw measurement values measured by one or more sensors on the monitoring device (e.g., electrical signals from the sensor). Examples of determining the parameter data can include determining the parameter value based on the measurements from the monitoring devices associated with a first substrate mass, determining the parameter value based on the measurements from the monitoring devices associated with a first and second substrate mass, or detecting the parameter based on any other suitable combination of information. The determined parameter value can be the nitrogen, phosphorous, and/or potassium concentration, the ratio of any one of the aforementioned ions relative to the other ions, the concentration and/or ratio of micronutrients, or any other suitable measure of a stressor indicator. The parameter value can be determined based on the amount, rate, and/or acceleration of measurement value deviation. For example, the ratio of nitrogen to potassium and phosphorous in a substrate can be determined based on the rate of measured electrical conductivity change. The parameter value can additionally or alternatively be the precipitation rate (e.g., determined based on the soil sensor measurements), evaporation rate (e.g., determined based on ambient environment and/or soil sensor measurements), or any other suitable characterization of water content. The parameter value can additionally include an evotranspiration rate or the amount of water lost to evotranspiration based on the precipitation rate, evaporation rate, and information on the plants planted in the substrate monitored by the monitoring device. However, any other suitable parameter value can be determined based on any other suitable set of measurements and/or data.

Receiving parameter data from the monitoring device can additionally include measuring the parameter data and/or the raw measurement values at the monitoring device. In one variation of the method, measuring parameter data includes measuring soil parameter data, more specifically soil resistance data but alternatively any other suitable ambient environment data. The soil parameter data is preferably measured by the electrical conductivity meter, wherein the first and second electrodes of the EC meter are held at a first and second electrical potential to induce a voltage therebetween, and the resultant current measured to determine the resistivity of the soil. The voltage can be held constant or varied (e.g., to increase measurement accuracy and accommodate for ions in the soil). In the latter variation, the voltage can be cycled through a set of predetermined voltages, selected based on other ambient environment parameters (e.g., temperature, humidity, etc.), varied at random, or otherwise varied. The voltage is preferably varied each time a measurement event occurs, but can alternatively be varied at any other suitable time. In a specific variation, the voltage is varied between 2.8 and 30.2V. Other measurements can include the ambient light intensity, ambient humidity, ambient temperature, or any other suitable measurement. The measurements can be encrypted by the monitoring system prior to transmission to a secondary computing system, or remain unsecured.

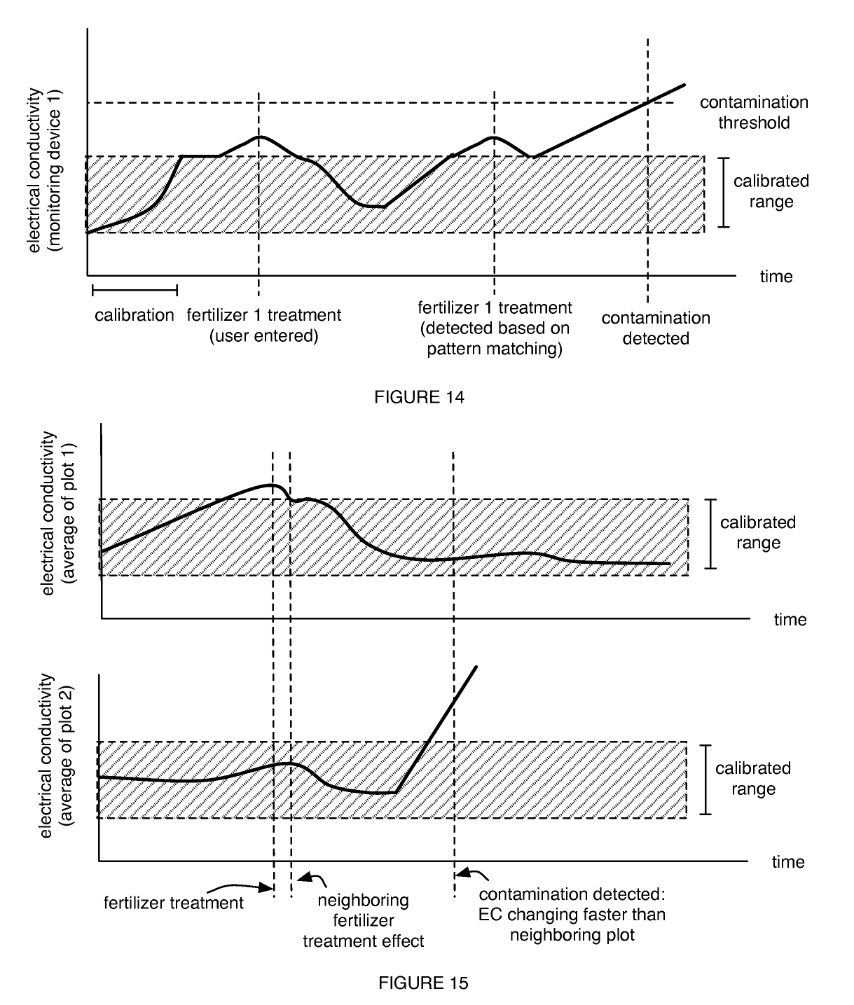

The method can additionally include determining the type of previously applied treatment based on the determined parameter value, wherein the determined parameter value can function as a signature for a given type or brand of treatment. For example, as shown in FIG. 14, the rate of electrical conductivity change for the given crop type, crop density, ambient environment characteristics, soil type, and/or any other suitable environment parameter can be used to automatically determine which type of fertilizer was applied to the substrate. The signature soil or ambient environment changes are preferably stored in a database (e.g., on-board or in a remote system), and can be empirically determined, predetermined, learned (e.g., based on association between user treatment entry into the system and subsequent parameter changes), or otherwise determined. Alternatively, the determined parameter value or a change in the measured parameter values can be used to detect a precipitation event (e.g., rain), evaporation (e.g., based on the temperature, humidity, and light measurements), or any other suitable treatment application and/or removal event. Parameters of treatment application and/or removal, such as the application or removal rate can additionally be determined from the parameter values. The treatment application and/or removal parameters can subsequently be used to determine plant health or any other suitable piece of plant-related information. In a specific example, the amount of water consumed by the plant can be determined based on the amount of water applied to the plant, the amount of water evaporated from the substrate surrounding the plant, and the amount of water remaining in the substrate surrounding the plant (e.g., amount of soil saturation), which, in turn, were determined based on the parameter values.

The method can additionally include detecting the presence of plot contamination. For example, as shown in FIG. 15, the presence of contamination can be determined based on a comparison between the parameter measurements from a first substrate mass (e.g., a first plot of soil) and a second substrate mass (e.g., a second plot of soil). The first substrate mass can be associated with a first set of parameter measurements (first data set), and is associated with a first geographic location and a first user account. The second substrate mass can be associated with a second set of parameter measurements (second data set), and is associated with a second geographic location and second user account, wherein first and second geographic locations are within a predetermined distance of each other (e.g., neighboring plots). Contamination can be detected in response to determination of a difference in a first contamination parameter determined based on the first data set and a second contamination parameter determined based on the second data set. The difference can be a contamination parameter value difference, a difference in the rate of change of the respective contamination parameter values, a difference in the change acceleration of the respective contamination parameter values, or any other suitable difference. The contamination parameter can be a measured parameter (e.g., the electrical conductivity), or can be determined from a combination of the measured parameters. The contamination parameter is preferably normalized to accommodate for treatment differences, baseline differences (e.g., baseline soil conductivity, light intensity, humidity, etc.), but can alternatively not be normalized. A notification can be sent to the user account associated with the contaminated plot of land. A remedying recommendation can additionally be generated and sent to the user account. In another example, detecting contamination can include comparing a monitoring device measurement (e.g., a near-instantaneous measurement) to a baseline range or value for the monitoring device 10. Contamination can be detected in response to the measurement value deviating from the baseline, deviating from the baseline faster than a signature treatment rate, exhibiting patterns consistent with contamination patterns, or determined in any other suitable manner.

Determining the output based on parameter data S220 functions to generate, select, or otherwise identify an output for the user associated with the monitoring device. The output can be generated for a single user account, a population of user accounts associated with a geographic region, a population of user accounts associated with a plurality of discontinuous geographic regions, or for any other suitable set of user accounts. The output can be determined for a user account based on the instantaneous or historical parameter values from monitoring devices associated with the respective user account, parameter values from monitoring devices associated with each of a plurality of user accounts (e.g., user accounts associated with a geographic region shared with the respective user account, all monitoring device data, etc.), weather forecasts for the geographic location identified by the monitoring device 10 (e.g., cloudiness, wind speed, amount of rain, etc.), news events, database information (e.g., hardiness zone information), purchase histories, user-entered information (e.g., fertilizer information entered by a user associated with a neighboring plot), or any other suitable information for the geographic region associated with the user account. The outputs can include predictions, histories, parameter determination, recommendations, notifications, or any other suitable output. The outputs are preferably outputs associated with plants (plant outputs), but can alternatively be outputs associated with the soil or any other suitable plant-growth influencer.

Examples of plant predictions include plant bloom dates and the number of days to plant or fruit maturity. For example, the plant bloom date can be estimated based on a comparison between the duration of daylight measured by the monitoring device 10, the total daylight duration for the geographic region (e.g., as determined from a weather database), the predicted amount of daylight the geographic region, and the photoperiod for the given crop, wherein the crop can be determined from the list of crops associated with a user account and the photoperiod can be determined from a crop database. Examples of plant or plot histories include historical treatments, ambient environment parameter values, plants planted in the plot, or any other suitable historical data.

Examples of plant recommendations include plant selection (crop selection) for the growing conditions proximal the monitoring device 10 (e.g., within a threshold range of the monitoring device 10), watering times (e.g., near-instantaneous watering need determination, watering schedule determination, etc.), plant groupings, plant or soil treatment types, treatment schedules, or any other suitable recommendations. The crop recommendation can be determined in response to receipt of a user request. The crop recommendation can be based on the geographic location of sensors 300 associated with the user account for which the recommendation is provided. In one example, the location is used to determine a hardiness zone for the sensors, and the hardiness zone can be used to select a crop to recommend to the user. The recommended crop is preferably additionally determined based on the crop profile for the crop. The crop profile can include a crop image, crop name, crop genus/species/variety/hybrid, description, optimal conditions (e.g., pH, temperature, soil type, fertilizer, watering schedule, light intensity, humidity, soil nutrient content, etc.), optimal photoperiod, growth time, optimal location, optimal season, expected yield, market price, recipes using the crop, wine pairings for the crop, similar crops, intercropping, genetically modified organism (GMO) status, or any other suitable crop parameter. The crop profile can be stored in a database. The crop can additionally be recommended based on the predicted growth environment for the respective geographic location (e.g., based on weather, insect growth cycles, etc.). The crop recommendation can additionally be determined based on social networking service information. For example, the crops recommended can be related to or selected based on crops bookmarked by the user or the social network service connections of the user. However, the crops can be recommended based on any other suitable information.

The treatment schedules (e.g., watering schedule, fertilization schedule, thinning schedule, etc.) can be predetermined or dynamically determined, based on the monitoring device measurements. The recommended treatments and/or treatment schedules can additionally be generated to meet a user-determined bloom date, harvest date, or any other suitable crop event. The recommended treatments and/or treatment schedule is preferably determined based on the crop being planted, the monitoring device measurements, and the predicted weather for the geographic location. The recommended treatments and/or treatment schedule can additionally be determined to optimize a user-selected crop parameter. For example, the recommended treatments and/or treatment schedule can be determined to maximize fruit flavor (e.g., sugar concentration), maximize fruit size, or optimize for any other suitable crop parameter. In the prior example, a schedule optimized for fruit flavor can schedule less frequent waterings, as compared to the schedule that optimizes for fruit size.

The method can additionally include automatically controlling treatment application based on the sensor measurements S280. The monitoring devices 10 preferably automatically control treatment application, but treatment application can alternatively be controlled by a user device 900 (e.g., automatically, in response to receipt of a treatment selection, etc.), a remote computing system 800, or any other suitable system. The treatment application is preferably controlled based on the treatment that was determined based on the instantaneous and/or historical sensor measurements (e.g., spot treatment, treatment schedule, etc.), but can alternatively or additionally be controlled based on a predetermined schedule, an altered treatment schedule, or based on any other suitable instructions.

In one example, the monitoring device 10 is wirelessly connected to a smart valve 30, wherein the smart valve 30 is connected to a water supply 60. The monitoring device 10 or other control mechanism can control valve 30 operation based on the monitoring device sensor measurements (e.g., based on instructions generated based on the sensor measurements), predetermined treatment schedules, treatment schedules adjusted based on the sensor measurements, or based on any other suitable treatment instruction. The monitoring device 10 preferably controls the smart valve 30 to selectively induce fluid flow therethrough at a target flow rate, such that the smart valve 30 controls when and how much water is supplied to the plants, but can alternatively control the smart valve 30 to permit fluid flow therethrough (e.g., wherein the water flow can additionally be controlled by a secondary system, such that the smart valve 30 selectively prevents water flow when the plants are scheduled to be watered but do not require watering, as determined from the measurements), or controlled in any other suitable manner.

The method can additionally include determining whether the smart valve power storage has enough power to switch operation modes from a closed mode to an open mode prior to switching valve operation modes. The method can additionally include determining whether the valve power storage has enough power to close the valve 620 prior to switching valve operation modes. The treatment is preferably rescheduled in response to a determination that the valve does not have enough power to open the valve, but any other suitable action can be taken. The treatment is preferably rescheduled in response to a determination that the valve does not have enough power to open and close the valve, but any other suitable action can be taken.

In another example, a first smart valve 30 can be connected to a water supply and a second smart valve 30 can be connected to a fertilizer supply, wherein the remote computing system 800, monitoring device 10, user device 900, or any other suitable device performing the method can instruct the first and second valves to selectively control the water and fertilizer application to the respective plot of land. However, the recommended schedule can be determined in any other suitable manner.

The method can additionally include refining recommendations, which functions to generate recommendations for users to better meet crop events, user preferences, target parameters, or any other suitable goal. In one variation, refining the recommendations includes sending a first treatment recommendation for plants proximal a monitoring device to a user device, detecting the recommended treatment at the monitoring device, receiving user-generated content about the plants, and adjusting the recommendation based on the received content. The user-generated content is preferably a set of images recorded by a user device, but can alternatively by any other suitable content generated in any other suitable manner. The user-generated content can be associated with a timestamp, a geographic location, or any other suitable metadata. The metadata can be subsequently used to identify the plant (e.g., through the location), to determine whether the content was generated before or after application of the recommended treatment, or to determine any other suitable relationship between the content and the treatment. The user-generated content is preferably posted to a virtual social networking system, wherein the social networking system preferably enables a plurality of users to interact with the user-generated content through respective user accounts.

The recommendation can be refined based on analysis of the content itself. For example, the content can be analyzed to extract plant indices (e.g., using a sensor parameter, such as the sensor color, as a reference point if included in the content), wherein the recommendation is refined based on the plant index values. For example, the recommendation can be positively reinforced (e.g., weighted higher) in response to the NDVI value exceeding a first threshold value, and negatively reinforced (e.g., weighted lower in response to the NDVI value falling below a second threshold value equal to or different from the threshold value.

The recommendation can additionally or alternatively be refined based on the amount of interaction with the user-generated content. For example, recommendations resulting in plant images garnering a large number of positive interactions from secondary users (e.g., more than a threshold number of positive interactions) can be weighted higher and/or subsequently recommended to other users having the same or similar starting parameters than recommendations resulting in plant images garnering a low number of positive interactions or a large number of negative interactions from secondary users. In another example, the change in the number of positive (or negative) interactions between a first piece of user content about the plant taken before the recommended treatment and a second piece of user content about the plant taken after the recommended treatment is used to adjust the recommendations, wherein a large change can result in recommendation promotion while a small change can result in recommendation degradation or stagnation. The interaction analysis can additionally be corrected for the content exposure rate. For example, even though a second image of the same plant garnered more “likes” than a first image, the associated recommendation might not be promoted if the number of connections to the respective user account increased between the time that the first image was posted and the time that the second image was posted. However, the secondary user interactions can be accommodated for in any other suitable manner. However, the recommendations can be refined based on any other suitable analysis of the user-generated content. The recommendations are preferably adjusted by increasing or decreasing a weighting associated with the recommendation for each of a set of starting parameters and/or targeted results, but can alternatively be adjusted in any other suitable manner.

An alternative embodiment preferably implements the above methods in a computer-readable medium storing computer-readable instructions. The instructions are preferably executed by computer-executable components preferably integrated with a substrate monitoring system. The substrate monitoring system can include a set of monitoring devices that measures the ambient environment of a substrate, and a parameter processing module that processes the measurements into recommendations, notifications, or any other suitable output. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A garden management system including a probe configured to insert into soil, the probe comprising:
a soil sensor;
a body arranged with a broad face perpendicular a longitudinal axis of the soil sensor, the body comprising:
a set of ambient environment sensors;
a geographic location mechanism;
a wireless communication mechanism;
a power supply electrically connected to and configured to power the soil sensor, ambient environment sensors, wireless communication mechanism, and geographic location mechanism; and
a renewable power source electrically connected to and configured to charge the power supply with harvested renewable power; and
a set of supports connecting the body to an end of the soil sensor, the body cooperatively defining a void with the set of supports.

2. The garden management system of claim 1, wherein the wireless communication mechanism comprises a mesh networking module and long-range communication module.

3. The garden management system of claim 1, wherein the body is hermetically sealed.

4. The garden management system of claim 3, wherein the body further comprises a magnetic switch configured to switch probe operation between an on and an off state.

5. The garden management system of claim 3, wherein the probe further comprises a plastic coating hermetically sealing the body, wherein the plastic coating encapsulates the body and a portion of the supports.

6. The garden management system of claim 1, wherein the soil sensor comprises an electrical conductivity meter.

7. The garden management system of claim 1, wherein the set of ambient environment sensors comprises a light sensor, humidity sensor, and temperature sensor.

8. The garden management system of claim 1, further comprising a valve wirelessly connected to the probe, the valve comprising:
a fluid manifold defining a fluid inlet and a fluid outlet;
a fluid flow controller arranged within the fluid manifold between the fluid inlet and fluid outlet, the flow controller operable between a set of positions and configured to control fluid flow through the fluid manifold using the set of flow controller positions;
a valve wireless communication module configured to receive control information from the probe;
a valve processor configured to control fluid flow controller operation based on information from the valve communication module;
a valve power supply electrically connected and configured to power the flow controller, valve wireless communication module, and valve processor; and
a valve renewable power source configured to harvest energy and charge the valve power supply using the harvested energy.

9. A garden management system including a probe, the probe comprising:
a soil sensor;
an ambient environment sensor;
a power supply;
a renewable power source electrically connected to and configured to charge the power supply with harvested renewable power;
a wireless communication mechanism;
a processor operable between:
a first mode in response to a renewable power parameter exceeding a parameter threshold, wherein the processor controls the wireless communication mechanism to transmit information at an increased rate; and
a second mode in response to the renewable power parameter falling below a second parameter threshold, wherein the processor controls the wireless communication mechanism to transmit information at a decreased rate.

10. The garden management system of claim 9, wherein the renewable power parameter comprises an anticipated power provision rate from the renewable power source.

11. The garden management system of claim 10, wherein the anticipated power provision rate is determined by the processor based on an ambient environment measurement received from the ambient environment sensor.

12. The garden management system of claim 11, wherein the probe further comprises a geographic location mechanism, wherein the anticipated power provision rate is further determined based on a weather forecast received from a remote database, wherein the weather forecast is determined based on a geographic location received from the geographic location mechanism.

13. The garden management system of claim 12, wherein the renewable power source comprises a solar panel and the ambient environment sensor comprises an ambient light sensor.

14. A method for garden management with a soil sensor, comprising, at a processor:
receiving a soil parameter measurement from a soil sensor;
receiving a geographic location associated with the soil sensor;
determining a plant recommendation based on the soil parameter measurement and auxiliary information associated with the geographic location; and
sending the plant recommendation to a user device associated with the remote probe.

15. The method of claim 14, wherein the plant recommendation comprises a set of plants to be grown proximal the remote probe.

16. The method of claim 14, wherein the plant recommendation comprises a watering recommendation.

17. The method of claim 16, further comprising controlling a remote valve based on the soil parameter measurement, comprising inducing fluid flow through the valve at a target flow rate, wherein the target flow rate is determined based on the soil parameter measurement.

18. The method of claim 14, further comprising comparing the soil parameter measurement to a baseline and sending a notification to the user device in response to the soil parameter measurement exceeding the baseline.

19. The method of claim 18, wherein the soil parameter comprises soil conductivity, the method further comprising establishing a baseline for the soil sensor, wherein establishing a baseline comprises:
at a first timestamp within a threshold duration of detecting fluid flow through a fluid manifold of a valve wirelessly connected to and located within a threshold distance of the soil sensor, recording a first soil conductivity value with the soil sensor;
at a second timestamp within a second threshold duration of detecting an end event, measuring a second soil conductivity value with the soil sensor; and
establishing a baseline range for the soil sensor based on the first and second soil conductivity values.

20. The method of claim 18, wherein the end event comprises detecting a soil saturation value exceeding a threshold value, comprising:
controlling the soil sensor to measure soil resistivity at a predetermined frequency; and
determining the soil saturation value based on the soil resistivity.
